(19) United States
(12) Patent Application Publication
(10) Pub. No.: US 2023/0062723 A1
(43) Pub. Date: Mar. 2, 2023

(54) SYSTEMS AND METHODS FOR MOUNTING A GRINDER/POLISHER SAMPLE HOLDER

(71) Applicant: Illinois Tool Works Inc., Glenview, IL (US)

(72) Inventors: David Geis, Chicago, IL (US); Alicia Burns, Vernon Hills, IL (US)

(21) Appl. No.: 17/892,191

(22) Filed: Aug. 22, 2022

Related U.S. Application Data
(60) Provisional application No. 63/238,861, filed on Aug. 31, 2021.

(51) Int. Cl. B23Q 3/06

(52) U.S. Cl. CPC B23Q 3/06

(57) ABSTRACT

Example systems and methods of a system for mounting a grinder/polisher sample holder are provided. The system includes a platform having one or more fasteners, upon which one or more mounting fixtures are arranged and mounted. The one or more mounting fixtures are configured to secure a sample holder in place for testing of the samples, such as a hardness test. One or more of the mounting fixtures may include mounting brackets to support the sample holder, and to fix an orientation and/or position of the sample holder. In examples, the mounting fixtures have interfaces to contact and support the sample holder when the sample holder is arranged within the system.

### CROSS-REFERENCE TO RELATED APPLICATIONS

This application hereby claims priority to and the benefit of U.S. Provisional Application Ser. No. 63/238,861, entitled “Systems And Methods For Mounting A Grinder/Polisher Sample Holder,” filed Aug. 31, 2021. The above listed U.S. Application is hereby incorporated by reference in its entireties for all purposes.

### BACKGROUND

Grinding and polishing operations are performed on specimens for numerous purposes and across a vast array of sectors and industries. In some applications, surface preparation of a specimen by grinding/polishing operations are performed in a grinding/polishing devices are capable of performing both grinding operations and polishing operations to work a specimen contained in a sample holder. If additional testing is to be performed on the specimen, it must be removed from the sample holder.

### SUMMARY

Systems and methods are disclosed of a system for mounting a grinder/polisher sample holder, substantially as illustrated by and described in connection with at least one of the figures, as set forth more completely in the claims.

### BRIEF DESCRIPTION OF THE DRAWINGS

FIG. 1 illustrates an example system for mounting a grinder/polisher sample holder, in accordance with aspects of this disclosure.

FIG. 2A illustrates a lateral view of the example system of FIG. 1.

FIG. 2B illustrates an exploded view of the example system of FIG. 1.

FIG. 3A illustrates a top view of the example system of FIG. 1.

FIG. 3B illustrates a cross-sectional view of an example mounting fixture of the example system of FIG. 1.

FIG. 4 is a perspective view of the example system of FIG. 1.

FIGS. 5A to 5C illustrate various views of the example system for mounting a grinder/polisher sample holder of FIG. 1 employed with a hardness testing machine, in accordance with aspects of this disclosure.

The figures are not necessarily to scale. Wherever appropriate, similar or identical reference numerals are used to refer to similar or identical components.

### DETAILED DESCRIPTION

Disclosed are systems and methods of a system for mounting a grinder/polisher sample holder. In particular, the system includes a platform having one or more fasteners, upon which one or more mounting fixtures are arranged and mounted. The one or more mounting fixtures are configured to secure the sample holder in place for testing of the samples, such as a hardness test. One or more of the mounting fixtures may include mounting brackets to support the sample holder, and to fix an orientation and/or position of the sample holder. In examples, the mounting fixtures have interfaces (e.g., hardened pins, contact tips, etc.) to contact and support the sample holder when the sample holder is arranged within the system.

As disclosed herein, the mounting system provides a sample holding fixture, which can be used with grinding/polishing systems, as well as hardness testing machines. For example, the sample holders are disc trays that hold multiple mounted samples or specimens (e.g., in a contained cartridge secured within the sample holder) in place for simultaneous grinding and/or polishing operations. Grinding/polishing systems involve grinding and/or polishing a specimen using one or more motors or other actuators. After polishing, the polished specimen may then be used to test a manufacturing or other process that resulted in the specimen, such as by performing visual inspection, hardness or density testing, and/or other desired testing.

Conventionally, an operator would have to remove individual specimens from the sample holder and load that specimen, individually, in another holding platform for hardness testing, for example. The result is additional time and resources devoted, not to testing, but to separating and arranging specimens.

The disclosed sample holding fixtures and systems enable the operator to move an entire sample holder tray and mount it directly onto the hardness tester without unloading individual specimens. This significantly reduces the amount of work required to test multiple specimens and reduces the chance for accidental scratches and/or other damage to the specimens.

In disclosed examples, a system for mounting a grinder/polisher sample holder includes a platform having one or more fasteners, and one or more mounting fixtures arranged on and mounted to the platform, the one or more mounting fixtures configured to secure a sample holder, each mounting fixture including one or more mounting brackets to fix an orientation or position of the sample holder, and one or more interfaces to contact and support the sample holder when the sample holder is arranged within the system.

In some examples, the one or more mounting fixtures comprises three or more fixtures distributed about the platform at an equal radial distance from a center point. In examples, each fixture of the one or more fixtures is separated by an equal distance between axial positions.

In some examples, the arrangement of the one or more mounting fixtures on the platform is adjustable based on a size or shape of the sample holder.

In some examples, a mounting bracket of the one or more mounting brackets is configured as an adjustable mounting bracket, the system further comprising a bracket lock to adjust a position or orientation adjustable mounting bracket to release and secure the sample holder to system.

In some examples, each mounting fixture further includes a base portion to mate with the platform, and a column extending from the base portion to support the interface. In examples, the one or more interfaces are mounted to an extension post extending from the column. In examples, the base portion is configured to be secured to the platform via the one or more fasteners.

In some examples, the one or more mounting brackets are secured to the one or more mounting fixtures via one or more bracket fasteners.

In some examples, the one or more interfaces are arranged to contact a first surface of the sample holder to limit movement of the sample holder in a first direction, and the brackets are configured to contact a second surface of the sample holder to limit movement of the sample holder in a second direction.

In some examples, the one or more mounting fixtures are formed of a metal such as stainless steel.

In some examples, the one or more interfaces are formed of a hardened material, such as carbide or steel.

In some examples, the one or more mounting fixtures support the sample holder at a distance from a surface of the platform that is greater than a length of a sample holder drive adapter.

In some examples, the system is configured to be incorporated in a hardness testing machine.

In some disclosed examples, a hardness testing system includes a grinder/polisher sample holder, and a system for mounting a grinder/polisher sample holder, including a platform comprising one or more fasteners, one or more mounting fixtures arranged on and mounted to the platform, the one or more mounting fixtures configured to secure a sample holder, each mounting fixture including one or more mounting brackets to fix an orientation or position of the sample holder, and one or more interfaces to contact and support the sample holder when the sample holder is arranged within the system.

In some examples, a platen configured for mounting the system for mounting a grinder/polisher sample holder is included.

In examples, the system for mounting a grinder/polisher sample holder further includes one or more alignment devices configured to mate with one or more alignment devices at the platen.

In some examples, an indenture device is included to test hardness of a sample within the sample holder by impacting the sample.

In some examples, a movable stage upon which the platen is secured is included, the movable stage configured to adjust a position or orientation of the sample relative to the indenture device.

In some examples, the platen further comprises one or more alignment devices to mate with the platform.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the term “embodiments” does not require that all disclosed embodiments include the discussed feature, advantage, or mode of operation.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.” and “for example” set off lists of one or more non-limiting examples, instances, or illustrations.

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

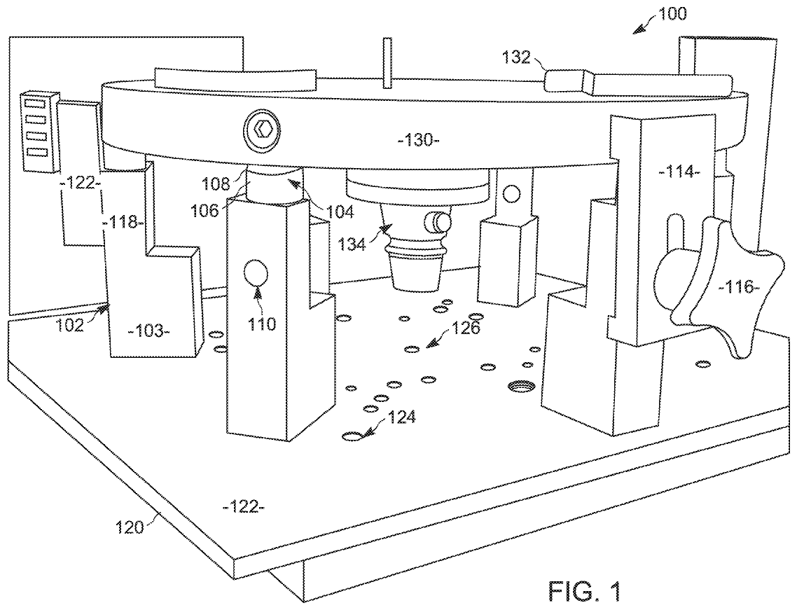

FIG. 1 illustrates an example fixture or system 100 for mounting a grinder/polisher sample holder 130. The system 100 includes one or more mounting fixtures 102 arranged on and mounted to a platform 120. As shown, the mounting fixtures 102 are configured to secure the sample holder 130, thereby fixing an orientation and/or position of the sample holder 130 in preparation of an operation, such as hardness testing.

Each mounting fixture can include one or more mounting brackets 112, which can be in a removably secured to a column 104 of the mounting fixture 102. For example, the mounting fixtures 102 can include one or more sample mounting bracket fasteners 110, such as a threaded hole to receive a bolt. In some examples, the mounting brackets 112 can be adjusted relative to the mounting fixture 102 and/or the sample, such as by raising, lowering, tilting, and/or sliding laterally, as a list of non-limiting examples. Example adjustable mounting locking bracket 114 is shown with a sample mounting locking bracket 116, although any variety of fasteners or bolts can be used. As shown in FIG. 1, the mounting brackets 112 are configured to contact a lateral surface of the sample holder to limit movement of the sample holder in a lateral direction. In some examples, one or more mounting brackets 112 may be configured to contact one or more of the top and/or bottom surfaces of the sample holder 130, and may be shaped to fit the contours of the sample holder 130 (e.g., curved).

In some examples, one or more interfaces 108 are formed on and/or secured to the column 118 to contact and support the sample holder 130 when the sample holder is arranged within the system 100, thereby limiting movement of the sample holder 130 in a downward direction. In some examples, the one or more interfaces 108 are formed integrally with the column 118. In some examples, the one or more interfaces 108 are formed separately (e.g., of a hardened material, such as carbide or steel) and secured directly to the column 118, whereas in some examples an extension post 106 is arranged to support the interface 108. In some examples, the extension posts 106 and/or the interfaces 108 may be removably secured to the mounting fixture 102. For instance, different extension posts 106 and/or the interfaces 108 may have a variety of characteristics (e.g., height, contact surface area, material composition, etc.) to accommodate different sample holders 130. In some examples, the extension posts 106 and/or the interfaces 108 may have fasteners or pins mating with fasteners on the sample holder 130 to further aid in securing the sample holder 130 in the system 100.

The example mounting fixtures 102 include a base portion 103, with the column 118 extending from the base portion 103 to support the extension posts 106, interfaces 108, and the sample holder 130. In some examples, the base portion is configured to rest on a surface 122 of a platform 120. For instance, one or more fasteners 124 are arranged on the platform 120 to receive a post, dowel, bolt, etc., to secure the base portion 103 to the platform 120.

As shown in the example of FIG. 1, the mounting fixtures 102 are configured to support the sample holder 130 at a distance from the surface 122 of the platform 120 that is greater than a length of a sample holder drive adapter 134. This arrangement ensures that the sample holder 130 can be taken from a grinding/polishing system and directly placed on the mounting system 100 without requiring modification to the sample holder 130.

In some examples, one or more of the mounting fixtures 102, the platform 120, the fasteners, the mounting brackets 112, 114, the bracket lock 116, and/or extension post are formed of a metal, such as stainless steel, and/or a composite material suitable to withstand impact from a hardness testing machine.

Although the mounting fixtures 102 are illustrated having a particular geometry (e.g., substantially L-shaped), any other suitable geometry can be used. Further, the mounting fixtures 102 are illustrated as a single part including a column and a base, where in some examples the mounting fixture can be formed of two or more parts.

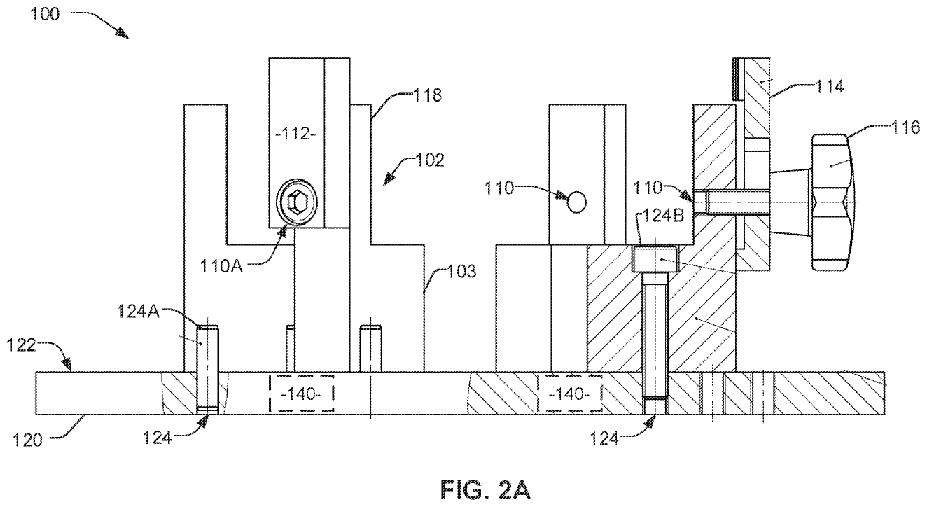

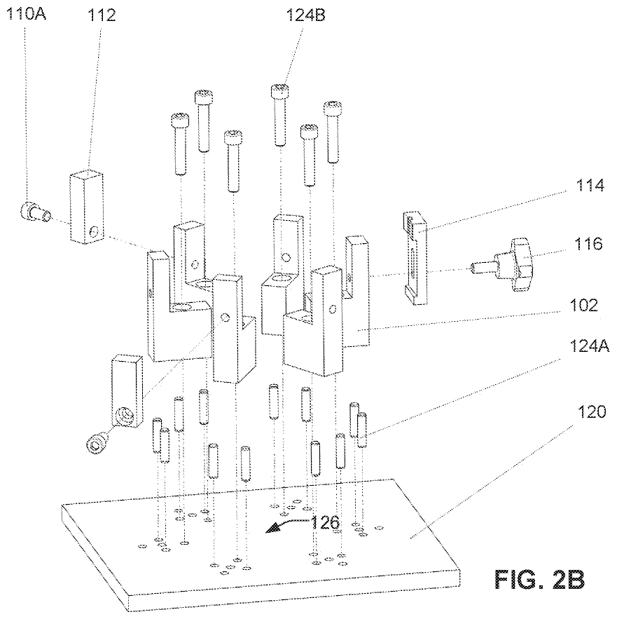

FIG. 2A illustrates a lateral view of the example system 100, with several features shown in cross-section. As shown, mounting fixtures 102 are mounted on the platform 120, and arranged on or near a fastener 124. To stabilize and/or secure the mounting fixtures 102 to the platform 120, one or more bolts 124B can secure the mounting fixture 102 to the platform 120. Additionally or alternatively, one or more posts 124A can be arranged adjacent to the base 103 to limit movement of the mounting fixtures 102.

In some examples, the platform 120 may include one or more alignment devices 140 to ensure consistent orientation of the platform 120 and system 100 in a hardness testing system, for example. In examples, the alignment devices 140 are magnets configured to mate with magnets of opposite polarity on a surface or platen of the hardness testing system. In some examples, one or more of magnets, posts, or openings can be employed to align the system 100, as a list of non-limiting examples.

FIG. 2B illustrates an exploded view of the example system of FIG. 1. As shown, six mounting fixtures 102 are arranged about the platform center point 126 to accommodate the sample holder 130. Each mounting fixture 102 is paired with two posts 124A and a single bolt 124B to secure and/or stabilize the mounting fixtures to the platform 120. In the example of FIG. 2B, two mounting brackets 112 are secured to two mounting fixtures 102 (via bolts 110A), the two mounting fixtures being separated by an adjacent mounting fixture. A third mounting fixture 102 is separated from the two mounting fixtures by two mounting fixtures adjacent the third mounting fixture, to which an adjustable mounting bracket 114 is releasably secured by bracket lock 116.

Although illustrated with six mounting fixtures, the system may use as few as one mounting fixture, and may use more than six mounting fixtures depending on the size, shape, and/or geometry of the sample holder, and/or a particular application or testing system. Although two mounting brackets and a single adjustable mounting bracket are shown, each mounting bracket used may be adjustable, or no adjustable mounting brackets may be used. Although the mounting fixtures are illustrated about a central point on the platform, in some examples the mounting features may have an asymmetrical arrangement on the platform.

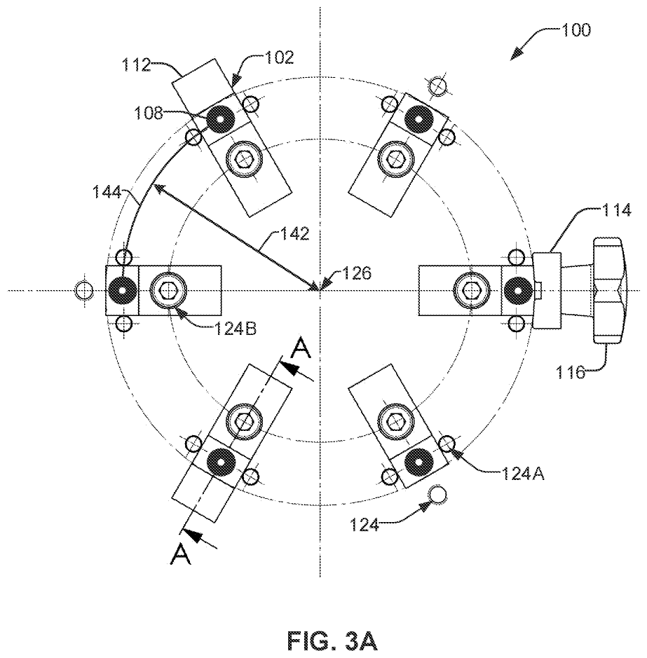

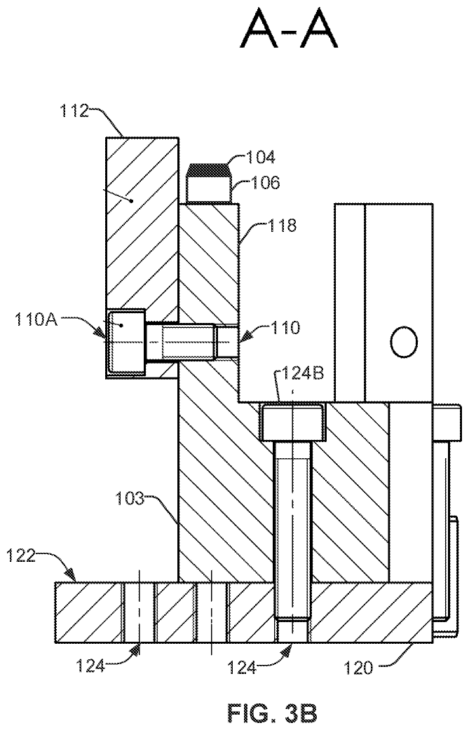

FIG. 3A illustrates a top view of the example system 100. As shown, the mounting fixtures 102 are distributed about the platform at an equal radial distance 142 from the center point 126. For example, the interfaces 108 can be at an equal distance from the center point to balance the force on the system 100 from the sample holder 130 during a testing operation (e.g., hardness testing). In some examples, the mounting fixtures are separated by an equal distance 144 between axial positions.

FIG. 3B illustrates a cross-sectional view along the A-A line shown in FIG. 3A, providing a detailed view of the fasteners 110, 110A to secure the mounting bracket 112 to the column 118, as well as fasteners 124 and 124B to secure the base 103 to the platform 120.

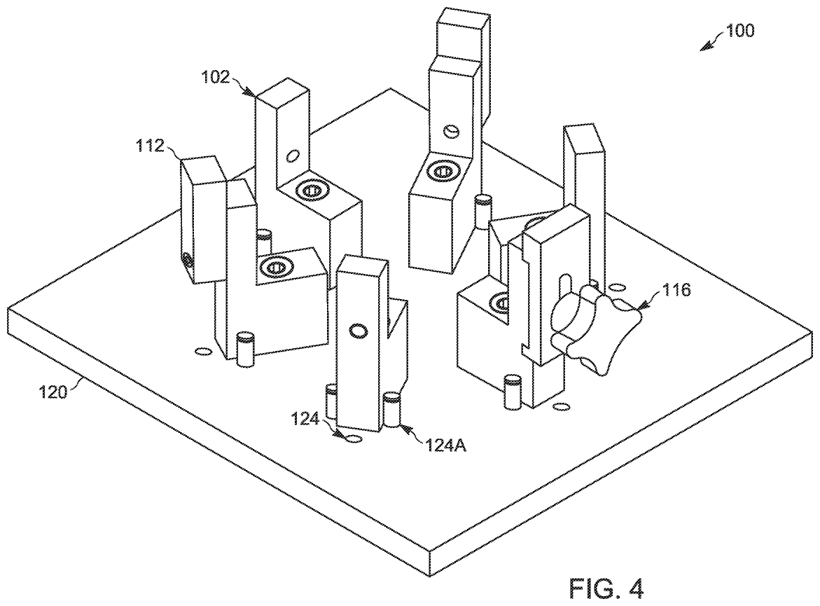

FIG. 4 is a perspective view of a block image of the example system 100 illustrated in FIG. 1, with the sample holder 130 removed.

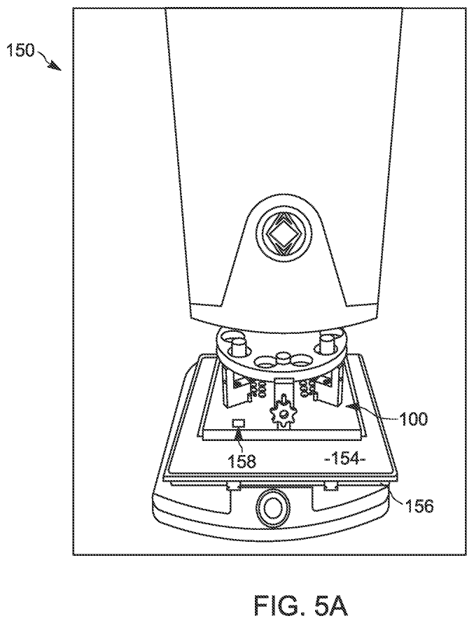

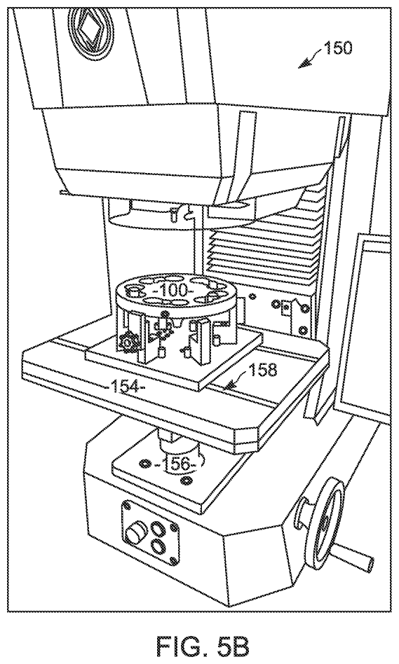

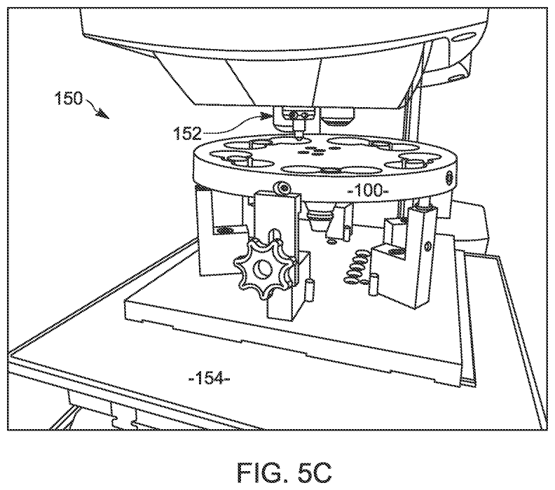

FIGS. 5A to 5C illustrate various views of the system for mounting a grinder/polisher sample holder 100 employed with a hardness testing machine 150. For example, the hardness testing machine 150 may include a platen 154 on which the system 100 may be placed. A hardness testing tool 152, such as an indenture device, is arranged above the platen 154 and configured to impact one or more of the samples 132 within the sample holder 130, causing an indent therein.

In some examples, the platen 154 includes one or more alignment devices 158 to mate with the platform 120. When aligned, the position of the samples 132 is easily determined by the hardness testing machine, such that the indenture device can impact one or more of the samples 132.

In some examples, the platen 154 is operably connected to an actuator driven movable stage 156. The actuator can be controlled by a controller (e.g., computing platform, processor, etc.) to move (e.g., shift, rotate, oscillate, etc.) the stage 156 relative to the indenture device 152 in order to move between and/or within a sample.

In some examples, the actuator is configured to move the stage 156 towards and/or away from the samples in order to adjust the load or force applied to sample (e.g., a linear-type actuator controlled to move or drive the platen towards and away from the specimen). Many types of actuators may be used to facilitate the testing operation.

In some examples, the sample holder 130 includes a number of specimen receiving slots configured to hold samples 132, which can be removed from the sample holder 130.

The foregoing description and accompanying figures illustrate the principles, preferred embodiments, and modes of operation. However, the disclosure should not be construed as being limited to the particular embodiments discussed above. Additional variations of the embodiments discussed above will be appreciated by those skilled in the art.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents. While the controllers and methods are described as being employed in connection with a grinding/polishing and/or hardness/density testing systems, the teachings may be similarly applied to other systems and operations.

All documents cited herein, including journal articles or abstracts, published or corresponding U.S. or foreign patent applications, issued or foreign patents, or any other documents are each entirely incorporated by reference herein, including all data, tables, figures, and text presented in the cited documents.

What is claimed is:

1. A system for mounting a grinder/polisher sample holder, comprising:
a platform comprising one or more fasteners; and
one or more mounting fixtures arranged on and mounted to the platform, the one or more mounting fixtures configured to secure a sample holder, each mounting fixture comprising:
one or more mounting brackets to fix an orientation or position of the sample holder; and
one or more interfaces to contact and support the sample holder when the sample holder is arranged within the system.

2. The system of claim 1, wherein the one or more mounting fixtures comprises three or more fixtures distributed about the platform at an equal radial distance from a center point.

3. The system of claim 2, wherein each fixture of the one or more fixtures is separated by an equal distance between axial positions.

4. The system of claim 1, wherein the arrangement of the one or more mounting fixtures on the platform is adjustable based on a size or shape of the sample holder.

5. The system of claim 1, wherein a mounting bracket of the one or more mounting brackets is configured as an adjustable mounting bracket, the system further comprising a bracket lock to adjust a position or orientation adjustable mounting bracket to release and secure the sample holder to system.

6. The system of claim 1, wherein each mounting fixture further comprises:
a base portion to mate with the platform; and
a column extending from the base portion to support the one or more interface.

7. The system of claim 6, wherein the one or more interfaces are mounted to an extension post extending from the column.

8. The system of claim 6, wherein the base portion is configured to be secured to the platform via the one or more fasteners.

9. The system of claim 1, wherein the one or more mounting brackets are secured to the one or more mounting fixtures via one or more bracket fasteners.

10. The system of claim 1, wherein the one or more interfaces are arranged to contact a first surface of the sample holder to limit movement of the sample holder in a first direction, and the brackets are configured to contact a second surface of the sample holder to limit movement of the sample holder in a second direction.

11. The system of claim 1, wherein the one or more mounting fixtures are formed of a metal such as stainless steel.

12. The system of claim 1, wherein the one or more interfaces are formed of a hardened material, such as carbide or steel.

13. The system of claim 1, wherein the one or more mounting fixtures support the sample holder at a distance from a surface of the platform that is greater than a length of a sample holder drive adapter.

14. The system of claim 1, wherein the system is configured to be incorporated in a hardness testing machine.

15. A hardness testing system, comprising:
a grinder/polisher sample holder; and
a system for mounting a grinder/polisher sample holder, comprising:
a platform comprising one or more fasteners;
one or more mounting fixtures arranged on and mounted to the platform, the one or more mounting fixtures configured to secure a sample holder, each mounting fixture comprising:
one or more mounting brackets to fix an orientation or position of the sample holder; and
one or more interfaces to contact and support the sample holder when the sample holder is arranged within the system.

16. The hardness testing system of claim 15, further comprising a platen configured for mounting the system for mounting a grinder/polisher sample holder.

17. The hardness testing system of claim 16, wherein the system for mounting a grinder/polisher sample holder further comprises one or more alignment devices configured to mate with one or more alignment devices at the platen.

18. The hardness testing system of claim 15, further comprising an indenture device to test hardness of a sample within the sample holder by impacting the sample.

19. The hardness testing system of claim 18, further comprising a movable stage upon which the platen is secured, the movable stage configured to adjust a position or orientation of the sample relative to the indenture device.

20. The hardness testing system of claim 16, wherein the platen further comprises one or more alignment devices to mate with the platform.
